(19) United States
(12) Patent Application Publication
(10) Pub. No.: US 2021/0178808 A1
(43) Pub. Date: Jun. 17, 2021

(54) VEHICLE WHEEL AND METHODS OF MAKING AND USING A VEHICLE WHEEL

(71) Applicant: Howmet Aerospace Inc., Pittsburgh, PA (US)

(72) Inventor: Douglas P. Mason, Livonia, MI (US)

(21) Appl. No.: 17/267,880

(22) PCT Filed: Oct. 26, 2018
(86) PCT No.: PCT/US2018/057674

§ 371 Date: Feb. 11, 2021

(51) Int. Cl. B60B 11/04; B60B 3/02

(52) U.S. Cl. CPC B60B 11/04; B60B 2900/325; B60B 2900/111; B60B 3/02

(57) ABSTRACT

A vehicle wheel for mounting at least two tires, an assembly comprising the vehicle wheel, methods of making the vehicle wheel, and methods of using the vehicle wheel. The vehicle wheel comprises a generally cylindrical first region, a generally cylindrical second region, a third region, and a fourth region. The first region comprises a first tire mount disposed about a circumference of an outer surface of the first region. The second region comprises a second tire mount disposed about a circumference of an outer surface of the second region. The third region is disposed intermediate and connecting the first region and the second region. The fourth region is integral with and extends radially inward from an inner surface of the third region. The fourth region is configured to mount to a vehicle axle. The first, second, third, and fourth regions are regions of a monolithic body.

### FIELD OF USE

The present disclosure relates to a vehicle wheel for mounting at least two tires, an assembly comprising the vehicle wheel, methods of making the vehicle wheel, and methods of using the vehicle wheel.

### BACKGROUND

Medium duty vehicles and heavy duty vehicles, such as semi-trucks, can carry loads in excess of 10 tons. To distribute these heavy loads efficiently to the ground, certain heavy duty vehicles can utilize wheels having dual tires mounted thereon at each wheel hub on a drive axle or trailer axle of the vehicles. Designing a vehicle wheel on which dual tries are mounted that can be efficiently replaced and operated presents challenges.

### SUMMARY

In one aspect, a vehicle wheel is provided. The vehicle wheel comprises a generally cylindrical first region, a generally cylindrical second region, a third region, and a fourth region. The first region comprises a first tire mount disposed about a circumference of an outer surface of the first region. The second region comprises a second tire mount disposed about a circumference of an outer surface of the second region. The third region is disposed intermediate and connects the first region and the second region. The fourth region is integral with and extends radially inwardly from an inner surface of the third region. The fourth region is configured to mount to a vehicle axle. The first, second, third, and fourth regions are regions of a monolithic body.

In another aspect, an assembly for a vehicle is provided. The assembly comprises a vehicle wheel, a first tire, and a second tire. The vehicle wheel comprises a generally cylindrical first region, a generally cylindrical second region, a third region, and a fourth region. The first region comprises a first tire mount disposed about a circumference of an outer surface of the first region. The second region comprises a second tire mount disposed about a circumference of an outer surface of the second region. The third region is disposed intermediate and connects the first region and the second region. The fourth region is integral with and extends radially inwardly from an inner surface of the third region. The fourth region is configured to mount to a vehicle axle. The first, second, third, and fourth regions are regions of a monolithic body. The first tire is mounted on the first region of the vehicle wheel. The second tire is mounted on the second region of the vehicle wheel. A gap is present between the first wheel and the second when mounted on the first region and second region, respectively.

In yet another aspect, a method comprising mounting a vehicle wheel on a drive axle of a vehicle or a trailer axle of a trailer is provided. The vehicle wheel comprises a generally cylindrical first region, a generally cylindrical second region, a third region, and a fourth region. The first region comprises a first tire mount disposed about a circumference of an outer surface of the first region. The second region comprises a second tire mount disposed about a circumference of an outer surface of the second region. The third region is disposed intermediate and connecting the first region and the second region. The fourth region is integral with and extends radially inwardly from an inner surface of the third region. The fourth region is configured to mount to a vehicle axle. The first, second, third, and fourth regions are regions of a monolithic body.

In a further aspect, a method of making a vehicle wheel is provided. The method comprises bonding, welding, forming, curing, forging, casting, or additively manufacturing at least one of a metal, a metal alloy, a plastic, and a composite to provide a monolithic vehicle wheel. The vehicle wheel comprises a generally cylindrical first region, a generally cylindrical second region, a third region, and a fourth region. The first region comprises a first tire mount disposed about a circumference of an outer surface of the first region. The second region comprises a second tire mount disposed about a circumference of an outer surface of the second region. The third region is disposed intermediate and connects the first region and the second region. The fourth region is integral with and extends radially inwardly from an inner surface of the third region. The fourth region is configured to mount to a vehicle axle. The first, second, third, and fourth regions are regions of a monolithic body.

It is understood that the invention disclosed and described in this specification is not limited to the aspects summarized in this Summary. The reader will appreciate the foregoing details, as well as others, upon considering the following detailed description of various non-limiting and non-exhaustive aspects according to this specification.

### BRIEF DESCRIPTION OF THE DRAWINGS

The features and advantages of the examples, and the manner of attaining them, will become more apparent, and the examples will be better understood, by reference to the following description taken in conjunction with the accompanying drawings, wherein:

FIG. 1A is a perspective view of a non-limiting embodiment of a vehicle wheel according to the present disclosure;

FIG. 1B is a side elevational detail view of the vehicle wheel of FIG. 1A;

FIG. 1C is a cross-sectional view of the vehicle wheel of FIG. 1A; and

FIG. 2 is a cross-sectional view of a non-limiting embodiment of an assembly comprising the vehicle wheel of FIG. 1A.

Corresponding reference characters indicate corresponding parts throughout the several views. The exemplifications set out herein illustrate certain embodiments, in one form, and such exemplifications are not to be construed as limiting the scope of the appended claims in any manner.

### DETAILED DESCRIPTION OF NON-LIMITING EMBODIMENTS

Various examples are described and illustrated herein to provide an overall understanding of the structure, function, and use of the disclosed articles and methods. The various examples described and illustrated herein are non-limiting and non-exhaustive. Thus, the invention is not limited by the description of the various non-limiting and non-exhaustive examples disclosed herein. Rather, the invention is defined solely by the claims. The features and characteristics illustrated and/or described in connection with various examples may be combined with the features and characteristics of other examples. Such modifications and variations are intended to be included within the scope of this specification. As such, the claims may be amended to recite any features or characteristics expressly or inherently described in, or otherwise expressly or inherently supported by, this specification. Further, Applicant reserves the right to amend the claims to affirmatively disclaim features or characteristics that may be present in the prior art. Therefore, any such amendments comply with the requirements of 35 U.S.C. § 112 and 35 U.S.C. § 132(a). The various embodiments disclosed and described in this specification can comprise, consist of, or consist essentially of the features and characteristics as variously described herein.

Any references herein to “various examples,” “some examples,” “one example,” “an example,” or like phrases means that a particular feature, structure, or characteristic described in connection with the example is included in at least one example. Thus, appearances of the phrases “in various examples,” “in some examples,” “in one example,” “in an example,” or like phrases in the specification do not necessarily refer to the same example. Furthermore, the particular described features, structures, or characteristics may be combined in any suitable manner in one or more examples. Thus, the particular features, structures, or characteristics illustrated or described in connection with one example may be combined, in whole or in part, with the features, structures, or characteristics of one or more other examples without limitation. Such modifications and variations are intended to be included within the scope of the present examples.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

The grammatical articles “a,” “an,” and “the,” as used herein, are intended to include “at least one” or “one or more,” unless otherwise indicated, even if “at least one” or “one or more” is expressly used in certain instances. Thus, the foregoing grammatical articles are used herein to refer to one or more than one (i.e., to “at least one”) of the particular identified elements. Further, the use of a singular noun includes the plural and the use of a plural noun includes the singular, unless the context of the usage requires otherwise.

As used herein, a referenced element or region that is “intermediate” two other elements or regions means that the referenced element/region is disposed between, but is not necessarily in contact with, the two other elements/regions. Accordingly, for example, a referenced element that is “intermediate” a first element and a second element may or may not be adjacent to or in contact with the first and/or second elements, and other elements may be disposed between the referenced element and the first and/or second elements.

A semi-truck can use dual wheels or a wide base wheel comprising a single tire spanning the width of the dual wheels on a drive axle or a trailer axle. The wide base wheel can have a decreased rotational mass as compared to the dual wheels, which can result in an increase in fuel savings. However, the wide base wheel can be more complex to produce, maintain, and repair compared to the dual wheels. A vehicle wheel that can be simpler to produce, maintain, and repair compared to the wide base wheel, and can have less rotational mass than the dual wheels, is provided herein. Various embodiments of using the vehicle wheel and of making the vehicle wheel also are provided.

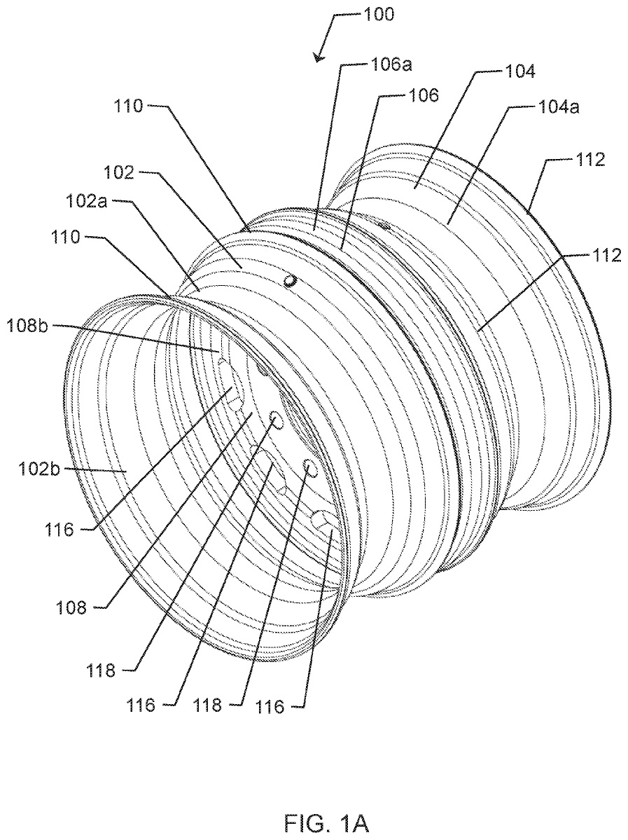

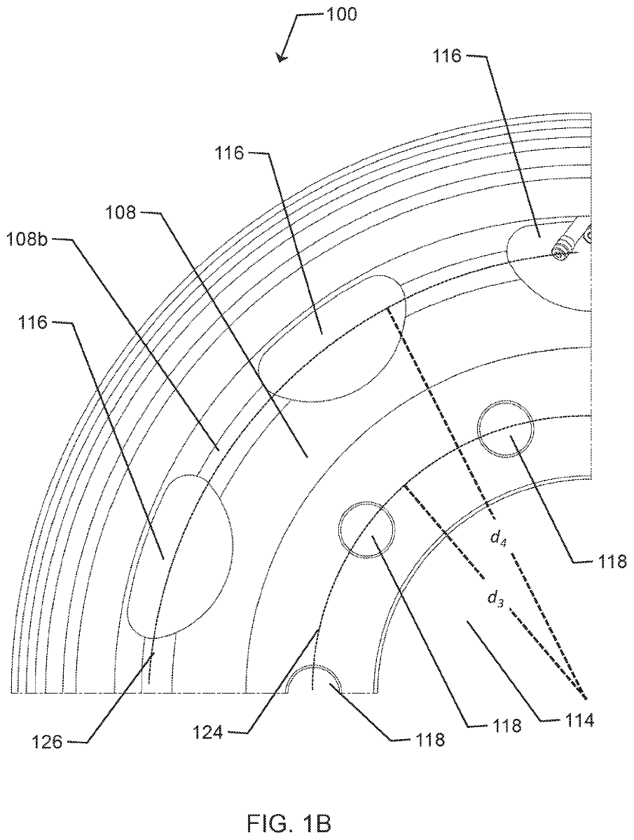

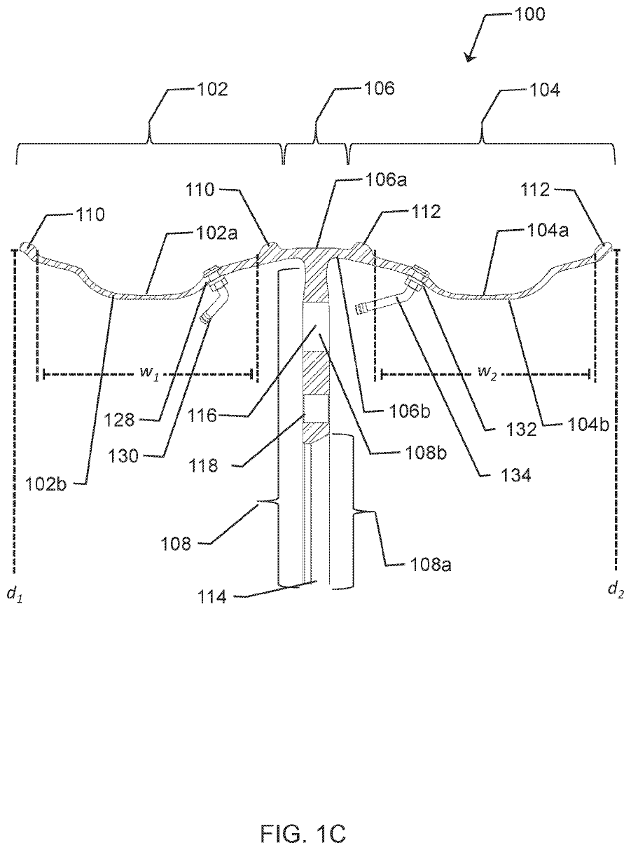

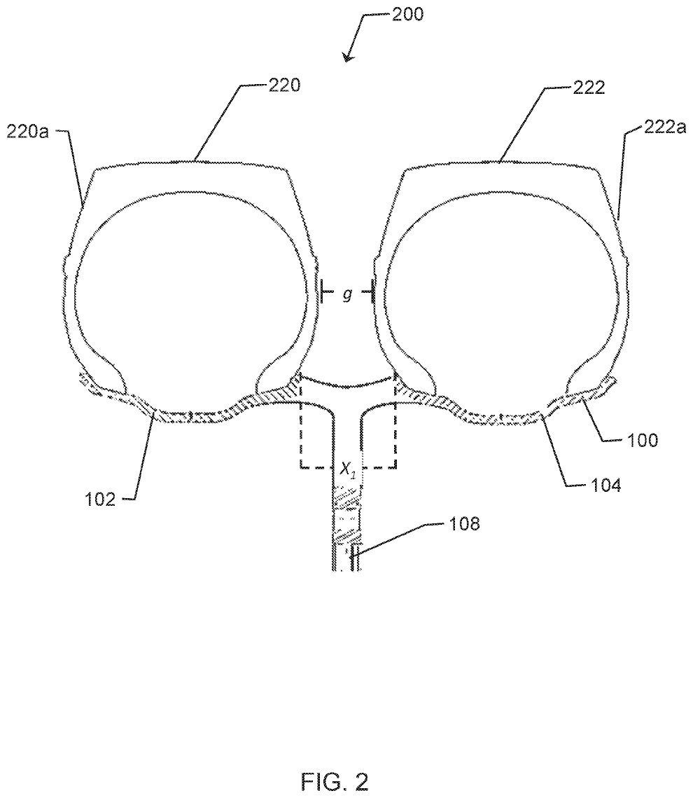

As illustrated in FIGS. 1A-C, a vehicle wheel 100 is provided. The vehicle wheel 100 comprises a first region 102, a second region 104, a third region 106, and a fourth region 108. The first region 102 is generally cylindrical and comprises an outer surface 102a and an inner surface 102b. The first region 102 further comprises a first tire mount 110 disposed about a circumference of the outer surface 102a of the first region 102. The second region 104 is generally cylindrical and comprises an outer surface 104a and an inner surface 104b. The second region 104 further comprises a second tire mount 112 disposed about a circumference of the outer surface 104b of the second region 104. The first tire mount 110 and the second tire mount 112 can be configured so that a tire can be mounted on each of the first tire mount 110 and the second tire mount 112. For example, the first tire mount 110 can comprise a tire bead set configured to receive a tire, and the second tire mount 112 also can comprise a tire bead seat configured to receive a tire. The mounting of a tire on each of the first tire mount 110 and the second tire mount 112 is illustrated in FIG. 2 and is described below.

In various embodiments, the first region 102 and the second region 104 extend in directions that are substantially parallel. In various embodiments, the first region 102 is symmetrical with the second region 104. In other embodiments, the first region 102 and the second region 104 do not extend in substantially parallel directions and/or are not symmetrical.

The first region 102 and the second region 104 can comprise a nominal rim width and a nominal rim diameter adapted to receive a tire. The first region 102 can comprise a nominal rim width, w₁, in a range of 6 inches (152.4 mm) to 12 inches (304.8 mm). For example, and without limitation, the nominal rim width, w₁, of the first region 102 can be 8.25 inches (209.6 mm) or 11 inches (279.4 mm). The second region 104 can comprise a nominal rim width, w₂, in a range of 6 inches (152.4 mm) to 12 inches (304.8 mm). For example, and without limitation, the nominal rim width, w₂, of the second region 104 can be 8.25 inches (209.6 mm) or 11 inches (279.4 mm).

The first region 102 can comprises a nominal rim diameter, d₁, in a range of 14 inches (406.4 mm) to 25 inches (635 mm). For example, and without limitation, the nominal rim diameter, d₁, of the first region 102 can be 22.5 inches (571.5 mm) or 24.5 inches (622.3 mm). The second region 104 can comprise a nominal rim diameter, d₂, in a range of 14 inches (406.4 mm) to 25 inches (635 mm). For example, and without limitation, the nominal rim diameter, d₂, of the second region 104 can be 22.5 inches (571.5 mm) or 24.5 inches (622.3 mm).

The third region 106 is disposed intermediate the first region 102 and the second region 104. In various embodiments, the third region 106 can connect the first region 102 and the second region 104. The third region 106 comprises an outer surface 106a and an inner surface 106b. The third region 106 can transfer force from the first region 102 and the second region 104 to the fourth region 108. In various embodiments, the third region 106 is adjacent to the first region 102 and the second region 104. In various embodiments, the third region 106 is generally cylindrical. In various embodiments, the third region 106 can comprise openings.

The fourth region 108 is integral with and extends radially inwardly from the inner surface 106b of the third region 106. In various embodiments, the fourth region 108 extends in a direction that is substantially perpendicular to the inner surface 106b of the third region 106. The fourth region 108 is configured to mount to a vehicle axle (not shown). For example, the fourth region 108 can comprise at least two bores 118 each configured to receive a stud on a hub of a vehicle axle. A center of each bore 118 can be disposed evenly about a circle 124. In various embodiments, the circle 124 has a center common with the fourth region 108. The circle 124 can comprise a diameter, d₃, in a range of 5 inches (127 mm) to 15 inches (381 mm). For example, and without limitation, the circle 124 can comprise a diameter, d₃, of 11.25 inches (285.75 mm). In various embodiments, each bore 118 can have a diameter in a range of 0.1 inches (2.54 mm) to 2 inches (50.8 mm). For example, the bore 118 can have a diameter of 1.023 inches (26 mm).

In various embodiments, the fourth region 108 can comprise a single bore suitable to mount to a vehicle axle having a single bolt. The single bore can comprise a diameter in a range of 1 inch (25.4 mm) to 10 inches (254 mm). In various embodiments, the fourth region 108 comprises an integral hub section configured to mount the vehicle wheel 100 to a vehicle axle using a single fastener.

The fourth region 108 can comprise a shape suitable to transfer force between a vehicle axle to the third region 106. In various embodiments, the fourth region 108 comprises a generally circular plate shape. In various embodiments, a center portion 108a of the fourth region 108 comprises an opening 114. The opening 114 can reduce a weight of the vehicle wheel 100.

In various embodiments, the fourth region 108 comprises at least two openings 116 disposed about a periphery 108b of the fourth region 108 and proximal to the inner surface 106b of the third region 106. The at least two openings 116 can reduce a weight of the vehicle wheel 100. In various embodiments, the fourth region 108 can comprise 10 openings 116. The openings 116 can be disposed offset from the bores 118. The offset disposition of the bores 118 and the openings 116 can minimize reduction in load rating, if any, of the vehicle wheel 100. Each opening 116 can be disposed evenly about a circle 126. In various embodiments, the circle 126 has a center common with the fourth region 108. The circle 126 can comprise a diameter, d₄, in a range of 10 inches (254 mm) to 22 inches (558.8 mm). For example, the circle 126 can comprise a diameter, d₄, of 17.3 inches (439.42 mm).

The first, second, third, and fourth regions 102, 104, 106, 108 are regions of a monolithic body of the vehicle wheel 110. The monolithic body is a single continuous piece of a material. The monolithic nature of the body can enhance force transfer between the regions 102, 104, 106, 108 and can enable reduction in weight of the vehicle wheel 100 versus conventional wheels on which two tires are mounted. In various embodiments, the monolithic body does not comprise fasteners to join the first, second, third, and fourth regions 102, 104, 106, 108 together.

In various embodiments, the vehicle wheel 100 can be at least one of a bonded wheel, a welded wheel, a formed wheel (e.g., vacuum formed), a cured wheel, a cast wheel, a forged wheel, and an additively manufactured wheel. The bonded, welded, formed, cured, cast, forged, or additively manufactured wheel may have been subjected to further processing to provide the final vehicle wheel. The vehicle wheel 100 can comprise at least one of a metal, a metal alloy, a plastic, and a composite. For example, the vehicle wheel 100 can comprise various materials suitable for making bonded, welded, formed, cured, cast, forged, and/or additively manufactured parts, such as, for example, at least one of aluminum, an aluminum alloy, titanium, titanium alloy, magnesium, magnesium alloy, iron, iron alloy, fiber glass, and carbon fiber.

In certain non-limiting embodiments, the vehicle wheel 100 can weigh no more than 75 pounds, such as, for example, no more than 70 pounds, or no more than 65 pounds. In various non-limiting embodiments, the vehicle wheel 100 can weigh at least 60 pounds, such as, for example, at least 65 pounds or at least 70 pounds. In various embodiments, the vehicle wheel can have a weight in a range of 60 pounds to 75 pounds.

In various embodiments, the load rating of the wheel can be at least 1,000 lbs, such as, for example, at least 5,000 lbs, at least 10,000 lbs, or at least 15,000 lbs. In various embodiments, the load rating of the wheel can be no greater than 20,000 lbs, such as, for example, no grater than 15,000 lbs, no greater than 10,000 lbs, or no greater than 5,000 lbs. In various embodiments, the load rating of the wheel can be 1,000 lbs to 20,000 lbs, such as, for example, 5,000 lbs to 15,000 lbs or 9,000 lbs to 13,000 lbs.

In various non-limiting embodiments, the first region 102 can comprises a first valve stem mount 128 and a first valve stem 130. In various non-limiting embodiments, the second region 104 can comprises a second valve stem mount 132 and a second valve stem 134. The valve stems 130, 134 are suitable to convey air to a tire mounted on the first region 102 and a tire mounted on the second region 104, respectively. In non-limiting embodiments where the vehicle wheel 100 is configured to be mounted on an axle of a vehicle and/or trailer with the first region 102 proximal to an exterior of the vehicle and/or trailer, the second valve stem mount 132 and the second valve stem 134 can be aligned with a hole 116 such that the second valve stem 134 can be accessed through the hole 116 without having to remove the vehicle wheel 100 from the axle.

As illustrated in FIG. 2, an assembly 200 can comprise the vehicle wheel 100, a first tire 220 mounted on the first tire mount 110, and a second tire 222 mounted on the second tire mount 112. The first tire 220 can contact the first tire mount 110 such that outer walls 220a of the first tire 220 are retained by the first tire mount 110. The second tire 222 can contact the second tire mount 112 such that outer walls 222a of the second tire 222 are retained by the second tire mount 112.

The first tire mount 110 and the second tire mount 112 can be axially spaced apart a distance, X₁, configured to provide a gap, g, between the first tire 220 and the second tire 222 when the tires are mounted on the first tire mount 110 and the second tire mount 112, respectively. The gap, g, can be of a size suitable to prevent or inhibit contact between the first tire 220 and the second tire 222. The first tire 220 and the second tire 222 can comprise various dimensions suitable to be mounted on the vehicle wheel 100. For example, in various non-limiting embodiments, the first tire 220 and the second tire 222 can comprise dimensions selected from at least one of 11R22.5, 295/75R22.5, 11R24.5, and 285175R24.5.

A method for using the vehicle wheel according to the present disclosure is provided. The method comprises mounting the vehicle wheel according to the present disclosure on a drive axle of a vehicle or a trailer axle of a trailer. The vehicle can comprise a vehicle weight class in a range of 1 to 8, such as, for example, 3 to 8 as defined by the U.S. Federal Highway Administration. For example, the gross weight of the vehicle can be at least 10,001 lbs. The vehicle can be a light duty, medium duty, or a heavy duty vehicle, such as, for example, a medium duty or heavy duty vehicle. In various non-limiting examples, the vehicle can be a truck (e.g., pick-up, full-sized, tractor (e.g., semi-truck)), a van, or a bus. The vehicle can comprise at least two axles, such as, for example, at least three axles, at least four axles, at least five axles, or at least six axles. In various non-limiting embodiments, the vehicle can comprise no greater than ten axles such as, for example, no greater than six axles, no greater than five axles, no greater than four axles, or no greater than three axles. In various non-limiting embodiments, the vehicle can comprise a quantity of axles in a range of two to ten.

The trailer can comprise a single axle or at least two axles, such as, for example, at least three axles, at least four axles, at least five axles, or at least six axles. In various non-limiting embodiments, the trailer can comprise no greater than ten axles such as, for example, no greater than six axles, no greater than five axles, no greater than four axles, or no greater than three axles. In various non-limiting embodiments, the trailer can comprise a quantity of axles in a range of one to ten.

A method of making a vehicle wheel according to the present disclosure also is provided. The method comprises bonding, welding, forming, curing, forging, casting, or additively manufacturing at least one of a metal, a metal alloy, a plastic, and a composite to provide a vehicle wheel according to the present disclosure. In various non-limiting embodiments, the method of making the vehicle wheel comprises steps in addition to the bonding, welding, forming, curing, casting, forging, or additive manufacturing. For example, the at least one of the metal, the metal alloy, the plastic, and the composite used to make the vehicle wheel can be various materials suitable for bonding, welding, forming, curing, casting, forging, and additive manufacturing, such as, for example, at least one of aluminum, an aluminum alloy, titanium, titanium alloy, magnesium, magnesium alloy, iron, iron alloy, fiber glass, and carbon fiber.

### Aspects of the Invention

Various aspects of the invention include, but are not limited to, the aspects listed in the following numbered clauses.
1. A vehicle wheel comprising:
   a generally cylindrical first region comprising a first tire mount disposed about a circumference of an outer surface of the first region;
   a generally cylindrical second region comprising a second tire mount disposed about a circumference of an outer surface of the second region;
   a third region disposed intermediate and connecting the first region and the second region; and
   a fourth region integral with and extending radially inwardly from an inner surface of the third region, the fourth region configured to mount to a vehicle axle, wherein the first, second, third, and fourth regions are regions of a monolithic body.
2. The vehicle wheel of clause 1, wherein the first region and the second region extend in directions that are substantially parallel.
3. The vehicle wheel of any one of clauses 1-2, wherein the fourth region extends in a direction that is substantially perpendicular to the inner surface of the third region.
4. The vehicle wheel of any one of clauses 1-3, wherein the fourth region comprises a generally circular plate shape.
5. The vehicle wheel of clause 4, wherein a center portion of the fourth region comprises an opening.
6. The vehicle wheel of any one of clauses 4-5, wherein the fourth region comprises at least two openings disposed about a periphery of the fourth region and proximal to the inner surface of the third region.
7. The vehicle wheel of any one of clauses 1-6, wherein the fourth region comprises an integral hub section configured to mount the vehicle wheel to a vehicle axle using a single fastener.
8. The vehicle wheel of any one of clauses 1-7, wherein the fourth region comprises at least two bores configured to receive a stud on a hub of a vehicle axle.
9. The vehicle wheel of any one of clauses 1-8, wherein at least one of the first tire mount and the second tire mount comprises a tire bead seat.
10. The vehicle wheel of any one of clauses 1-9, wherein at least one of the first region and the second region comprises a nominal rim diameter in a range of 1 inch to 200 inches, inclusive.
11. The vehicle wheel of any one of clauses 1-10, wherein at least one of the first region and the second region comprises a nominal rim width in a range of 1 inch to 100 inches, inclusive.
12. The vehicle wheel of any one of clauses 1-11, wherein the first tire mount and the second tire mount are axially spaced apart a distance configured to form a gap between a first tire mounted on the first tire mount and a second tire mounted on the second tire mount.
13. The vehicle wheel of clause 12, wherein at least one of the first region and the second region comprises a nominal rim diameter in a range of 14 inches to 25 inches, inclusive, and at least one of the first region and the second region comprises a nominal rim width in a range of 6 inches to 12 inches, inclusive.
14. The vehicle wheel of any one of clauses 1-13, wherein the vehicle wheel is at least one of a bonded wheel, a welded wheel, a formed wheel, a cured wheel, cast wheel, a forged wheel, and an additively manufactured wheel.
15. The vehicle wheel of any one of clauses 1-14, wherein the vehicle wheel comprises at least one of a metal, a metal alloy, a plastic, and a composite.
16. The vehicle wheel of any one of clauses 1-15, wherein the vehicle wheel comprises at least one of aluminum, an aluminum alloy, titanium, titanium alloy, magnesium, magnesium alloy, iron, iron alloy, fiber glass, and carbon fiber.
17. The vehicle wheel of any one of clauses 1-16, monolithic body does not comprise fasteners to join the first, second, third, and fourth regions.
18. An assembly for a vehicle comprising:
   the vehicle wheel recited in any one of clauses 1-17;
   a first tire mounted on the first region of the vehicle wheel; and
   a second tire mounted on the second region of the vehicle wheel;
   wherein a gap is present between the first wheel and the second wheel.
19. A method comprising mounting the vehicle wheel of any one of clauses 1-17 on a drive axle of a vehicle or a trailer axle of a trailer.
20. A method of producing a vehicle wheel, the method comprising:
   providing a monolithic vehicle wheel by a method comprising at least one of bonding, welding, forming, curing, forging, casting, and additively manufacturing at least one of a metal, a metal alloy, a plastic, and composite, the vehicle wheel comprising:
      a generally cylindrical first region comprising a first tire mount disposed about a circumference of an outer surface of the first region;
      a generally cylindrical second region comprising a second tire mount disposed about a circumference of an outer surface of the second region;
      a generally cylindrical third region disposed intermediate and connecting the first region and the second region; and
      a fourth region integral with and extending radially inwardly from an inner surface of the third region, the fourth region configured to mount to a vehicle axle, wherein the first, second, third, and fourth regions are regions of the monolithic vehicle wheel.

One skilled in the art will recognize that the herein described articles and methods, and the discussion accompanying them, are used as examples for the sake of conceptual clarity and that various configuration modifications are contemplated. Consequently, as used herein, the specific examples/embodiments set forth and the accompanying discussion are intended to be representative of their more general classes. In general, use of any specific exemplar is intended to be representative of its class, and the non-inclusion of specific components, devices, operations/actions, and objects should not be taken to be limiting. While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

What is claimed is:

1. A vehicle wheel comprising:
a generally cylindrical first region comprising a first tire mount disposed about a circumference of an outer surface of the first region;
a generally cylindrical second region comprising a second tire mount disposed about a circumference of an outer surface of the second region;
a third region disposed intermediate and connecting the first region and the second region; and
a fourth region integral with and extending radially inwardly from an inner surface of the third region, the fourth region configured to mount to a vehicle axle, wherein the first, second, third, and fourth regions are regions of a monolithic body.

2. The vehicle wheel of claim 1, wherein the first region and the second region extend in directions that are substantially parallel.

3. The vehicle wheel of claim 1, wherein the fourth region extends in a direction that is substantially perpendicular to the inner surface of the third region.

4. The vehicle wheel of claim 1, wherein the fourth region comprises a generally circular plate shape.

5. The vehicle wheel of claim 4, wherein a center portion of the fourth region comprises an opening.

6. The vehicle wheel of claim 4, wherein the fourth region comprises at least two openings disposed about a periphery of the fourth region and proximal to the inner surface of the third region.

7. The vehicle wheel of claim 1, wherein the fourth region comprises an integral hub section configured to mount the vehicle wheel to a vehicle axle using a single fastener.

8. The vehicle wheel of claim 1, wherein the fourth region comprises at least two bores configured to receive a stud on a hub of a vehicle axle.

9. The vehicle wheel of claim 1, wherein at least one of the first tire mount and the second tire mount comprises a tire bead seat.

10. The vehicle wheel of claim 1, wherein at least one of the first region and the second region comprises a nominal rim diameter in a range of 1 inch to 200 inches, inclusive.

11. The vehicle wheel of claim 1, wherein at least one of the first region and the second region comprises a nominal rim width in a range of 1 inch to 100 inches, inclusive.

12. The vehicle wheel of claim 1, wherein the first tire mount and the second tire mount are axially spaced apart a distance configured to form a gap between a first tire mounted on the first tire mount and a second tire mounted on the second tire mount.

13. The vehicle wheel of claim 12, wherein at least one of the first region and the second region comprises a nominal rim diameter in a range of 14 inches to 25 inches, inclusive, and at least one of the first region and the second region comprises a nominal rim width in a range of 6 inches to 12 inches, inclusive.

14. The vehicle wheel of claim 1, wherein the vehicle wheel is at least one of a bonded wheel, a welded wheel, a formed wheel, a cured wheel, cast wheel, a forged wheel, and an additively manufactured wheel.

15. The vehicle wheel of claim 1, wherein the vehicle wheel comprises at least one of a metal, a metal alloy, a plastic, and a composite.

16. The vehicle wheel of claim 1, wherein the vehicle wheel comprises at least one of aluminum, an aluminum alloy, titanium, titanium alloy, magnesium, magnesium alloy, iron, iron alloy, fiber glass, and carbon fiber.

17. The vehicle wheel of claim 1, wherein the monolithic body does not comprise fasteners to join the first, second, third, and fourth regions.

18. An assembly for a vehicle comprising:
the vehicle wheel recited in claim 1;
a first tire mounted on the first region of the vehicle wheel; and
a second tire mounted on the second region of the vehicle wheel;
wherein a gap is present between the first wheel and the second wheel.

19. A method comprising mounting the vehicle wheel of claim 1 on a drive axle of a vehicle or a trailer axle of a trailer.

20. A method of producing a vehicle wheel, the method comprising:
providing a monolithic vehicle wheel by a method comprising at least one of bonding, welding, forming, curing, forging, casting, and additively manufacturing at least one of metal, a metal alloy, a plastic, and a composite, the vehicle wheel comprising:
a generally cylindrical first region comprising a first tire mount disposed about a circumference of an outer surface of the first region;
a generally cylindrical second region comprising a second tire mount disposed about a circumference of an outer surface of the second region;
a generally cylindrical third region disposed intermediate and connecting the first region and the second region; and
a fourth region integral with and extending radially inwardly from an inner surface of the third region, the fourth region configured to mount to a vehicle axle, wherein the first, second, third, and fourth regions are regions of the monolithic vehicle wheel.
